(19) United States
(12) Patent Application Publication
(10) Pub. No.: US 2014/0060545 A1
(43) Pub. Date: Mar. 6, 2014

(54) Apparatus for ejecting an oxygen mask

(71) Applicant: INTERTECHNIQUE, Plaisir Cedex (FR)

(72) Inventors: Marco Hollm, Rosdorf (DE); Andreas Westphal, Eutin (DE)

(21) Appl. No.: 14/017,413

(22) Filed: Sep. 4, 2013

(30) Foreign Application Priority Data
Sep. 5, 2012 (EP) 12183217.4

(51) Int. Cl. A62B 7/14; A62B 18/02; A62B 7/02

(52) U.S. Cl. CPC A62B 7/14; A62B 7/02; A62B 18/02
USPC 128/206.27

(57) ABSTRACT

The invention relates to an apparatus for ejecting an oxygen mask. The apparatus comprises a housing (3) provided with a housing opening (9) and having a housing cover (5) which can be moved between a closed position (7) in which the housing opening (9) is covered at least in sections by the housing cover (5), and an open position (50), an oxygen mask (12; 13) disposed inside the housing (3), in the closed position (7), and an ejector strap (20; 22) having one end (25; 27) which is connected to the housing cover (5). The invention is further characterized in that the ejector strap (20; 22) co-operates in the closed position (7) with a side of the oxygen mask (12; 13) which faces away from the housing cover (5), such that the oxygen mask (12; 13) is ejected from the housing (3) by the housing cover (5) moving into the open position (50).

### CROSS-REFERENCE TO RELATED APPLICATION

This application claims priority to and benefit of European Patent Application No. 12183217.4 filed on Sep. 5, 2012, the contents of which are incorporated herein by this reference.

### FIELD OF THE INVENTION

The invention relates to an apparatus for ejecting an oxygen mask, comprising a housing provided with a housing opening and having a housing cover which can be moved between a closed position in which the housing opening is covered at least in sections by the housing cover, and an open position, an oxygen mask disposed inside the housing, in the closed position, and an ejector strap having one end which is connected to the housing cover.

### BACKGROUND OF THE INVENTION

Apparatuses for ejecting oxygen masks are known from aviation, in particular, for example in aircraft. If the cabin in the passenger cabin of an aircraft drops, it is imperative that an oxygen mask be ejected from the housing, so that the passenger can put on the oxygen mask promptly after the pressure drop in order to be supplied with oxygen. The housing is generally disposed near the head of the passenger. It is therefore desirable, for the safety of the passengers and the crew members of an aircraft, that the oxygen masks be ejected from the housing in a particularly reliable manner.

### SUMMARY OF THE INVENTION

Within that context, the object of the present invention is to specify an improved apparatus for ejecting an oxygen mask.

This object is achieved, according to the invention, by an apparatus of the kind initially specified, in which the ejector strap co-operates in the closed position with a side of the oxygen mask which faces away from the housing cover, such that the oxygen mask is ejected from the housing by the housing cover moving into the open position.

It was not realized until the invention that, in prior art apparatuses for ejecting oxygen masks, an ejector strap is attached to both the housing and to the housing cover. When the housing cover is in the opened state, the ejector strap was tensioned to such an extent that the oxygen mask was ejected from the housing. When the ejector device was used improperly, for example by untrained personnel, the ejector strap was often placed loosely between the housing cover and the oxygen mask when closing the housing cover, with the result that the ejector strap was unable to perform its ejector function when the housing cover moved into the open position, i.e., the oxygen mask was left lying or hanging inside the housing.

These disadvantages are overcome by the present invention, i.e., due to the ejector strap no longer being connected to the housing, it is unmistakeably clear to an operator how the ejector strap has to be arranged when closing the housing cover (e.g., after testing the apparatus), namely in such a way that the ejector strap can co-operate in the closed position of the housing cover with a side of the oxygen mask facing away from the housing cover. Reliable ejection of the oxygen mask from the housing is thus achieved with the present invention.

The expression “housing” in the context of the present invention should preferably be understood to mean a substantially cuboidal housing made of plastic, for example, and which is embedded in an element of the passenger cabin, for example in the seat in front, or in a unit above the passenger. In the context of the present invention, a “housing opening” may be understood to mean that a flat side of the cuboidal housing is open, i.e., the side has no housing wall. The expression “housing cover” can further be understood in the context of the present invention to mean a wall made of plastic, with a wide side having an area that is substantially identical to the area of the opening. The oxygen mask is preferably an oxygen mask of the kind that is generally used in passenger aircraft.

The expression “ejector strap” is preferably to be understood in the context of the present invention to mean a strap consisting of a textile material.

According to a preferred embodiment of the apparatus according to the invention, the ejector strap engages at least partially behind a side of the oxygen mask facing away from the housing cover. Co-operation between the ejector strap and a side of the oxygen mask facing the housing cover is thus provided in a particularly simple form.

According to another preferred embodiment of the apparatus according to the invention, the ejector strap engages at least partially behind a side of the oxygen mask facing away from the housing cover by means of a pouch in the ejector strap. The pouch is preferably formed in an end region of the ejector strap. The ejector strap preferably has a length that is favorable for ejection of the oxygen mask.

It is further preferred that the ejector strap be formed, in the closed position, by the end which is connected to the housing cover, a transitional section extending from said end along one side, preferably above the oxygen mask, an engagement section extending from the transitional section along a side facing away from the housing cover, and an end section extending from the engagement section along another side, preferably underneath the oxygen mask. It is further preferred that the ejector strap includes a lateral section extending laterally along the ejector strap between the engagement section and the end section. The pouch is preferably formed by the engagement section, the end section and the lateral section.

In yet another preferred embodiment of the apparatus according to the invention, the housing cover is pivotable between the closed position and the open position. This should be understood in such a way that the housing cover is connected at one end of the housing cover by means of a hinge to the housing, in particular to an edge of the housing opening. The housing cover is flipped open by pivoting from the closed position to the open position, or flipped shut from the open position to the closed position.

### BRIEF DESCRIPTION OF THE INVENTION

A preferred embodiment of the invention shall now be described with reference to the attached Figures, in which:

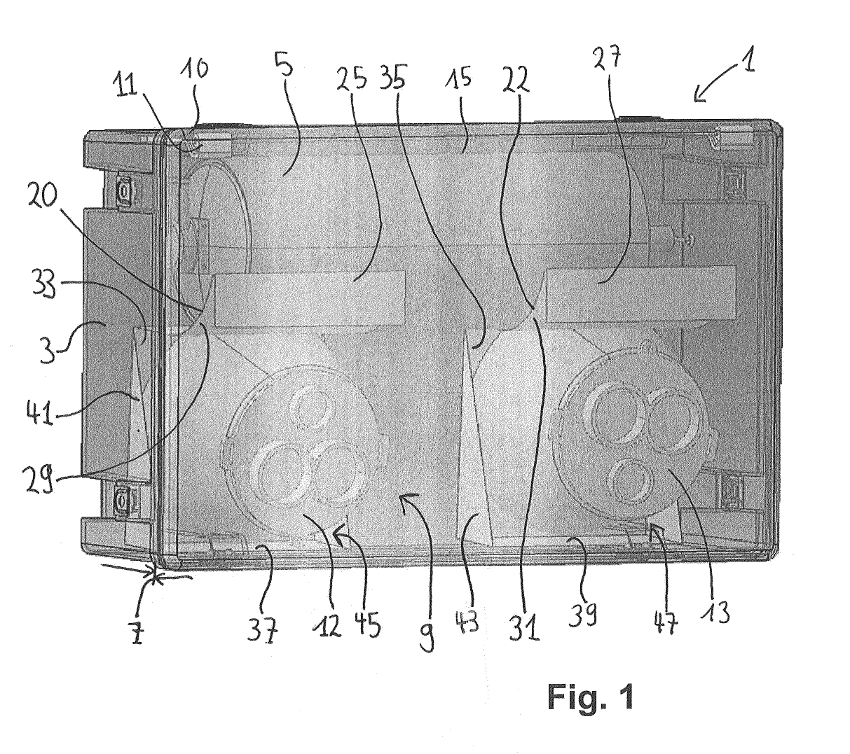

FIG. 1 shows a perspective view of an embodiment of the inventive apparatus in a first state,

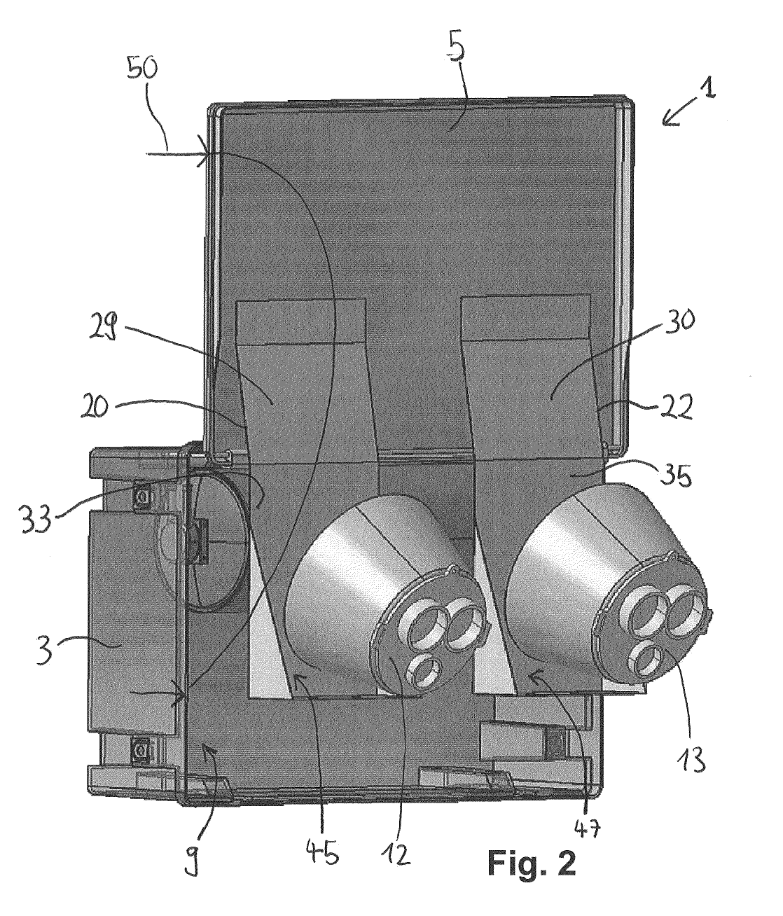

FIG. 2 shows a perspective view of the embodiment of the inventive apparatus shown in FIG. 1, in a second state,

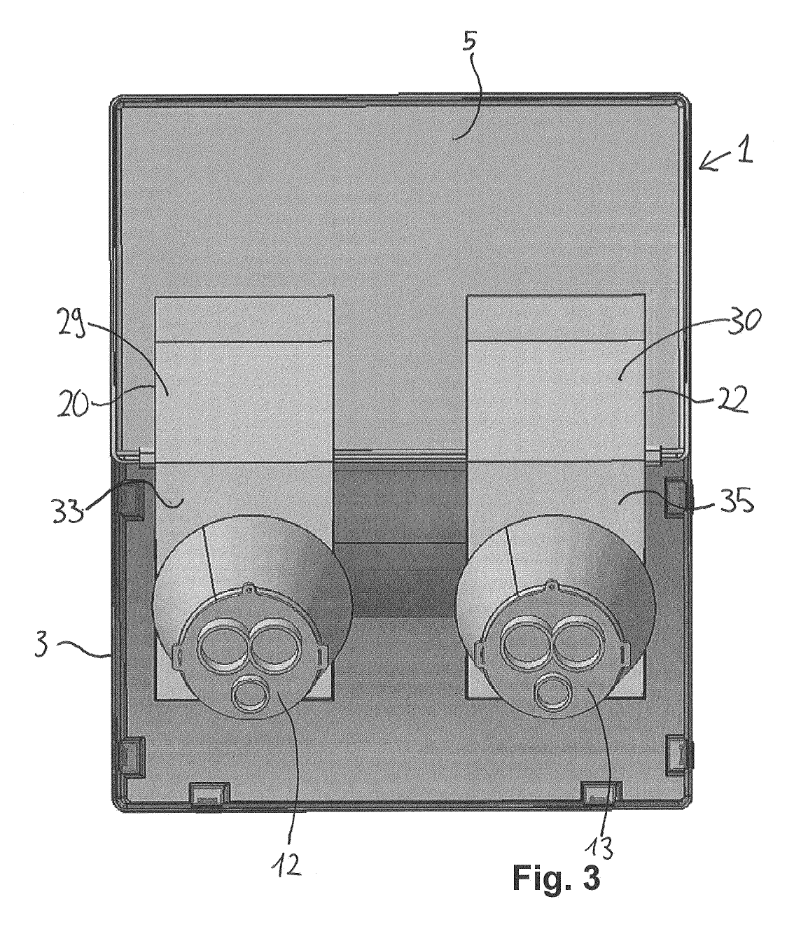

FIG. 3 shows a front view of the embodiment of the inventive apparatus shown in FIGS. 1 and 2, in the second state and

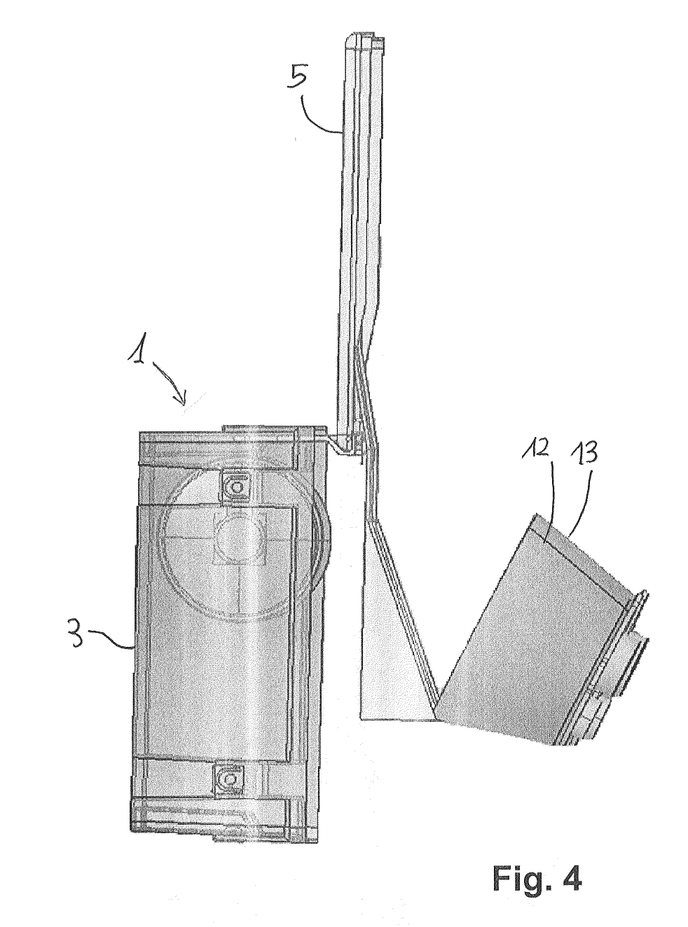

FIG. 4 shows a side view of the embodiment of the inventive apparatus shown in FIGS. 1 to 3, in the second state.

### DETAILED DESCRIPTION OF THE INVENTION

FIGS. 1 to 4 show an embodiment of an apparatus 1 according to the invention in a first and second state. FIG. 1 shows the apparatus 1 comprising a housing 3 and a housing cover 5. Housing cover 5 is pivotable between the closed position 7 shown in FIG. 1 and an open position shown in FIGS. 2 to 4. In other words, the first state of the apparatus is characterized in that housing cover 5 is in a closed position 7. In said closed position 7, a housing opening 9 is covered by housing cover 5. The housing 5 in FIG. 1 is shown with partially transparent housing walls, so that housing opening 9 can be seen through housing cover 5 in the viewing direction of FIG. 1. Housing cover 5 is connected at one end 10 to housing 3 by means of a hinge 11 for pivoting the housing cover 5.

In the state shown in FIG. 1, two oxygen masks 12 and 13 are arranged adjacent one another inside the housing. An oxygen container 15 for supplying oxygen masks 12 and 13 with oxygen is disposed above oxygen masks 12 and 13. Oxygen from the oxygen container 15 is transferred via supply tubes, not shown in the Figure, to oxygen masks 12 and 13. Oxygen masks 12 and 13, the supply tubes and the oxygen container 15 together form an oxygen module.

Each of oxygen masks 12 and 13 is assigned a respective ejector strap 20, 22. Ejector strap 20, 22 is fixedly connected at one end 25, 27 to housing cover 5. Ejector strap 20, 22 extends above oxygen masks 12, 13 from said end and then downward on the side of oxygen masks 12 and 13 facing away from housing cover 5. In other words, from end 25, 27 of ejector band 20, 22, a transitional section 29, 31 of ejector strap 20, 22 runs above oxygen masks 12, 13. An engagement section 33, 35 of ejector strap 20, 22 extends from said transitional section 29, 31 along one side of oxygen masks 12 and 13 facing away from housing cover 5. From engagement section 33, 35, an end section 37, 39 of ejector band 20, 22 extends partially underneath oxygen masks 12, 13. Finally, a lateral section 41, 43 of ejector band 20, 22 extends laterally along the ejector strap between engagement section 33, 35 and end section 37, 39. The engagement section, end section and the lateral sections form a pouch 45, 47 in the ejector band 20, 22.

FIGS. 2 to 4 show apparatus 1 in the second state, in which housing cover 5 is in an open position 50 in which housing opening 9 is open. Identical elements and functionally equivalent elements are provided with the same reference signs in the various Figures. In the open position 50, ejector strap 20, 22 is at least partially stretched, i.e. transitional section 29, 31 and engagement section 33, 35 form a substantially straight course of ejector strap 20, 22.

FIGS. 2 to 4 each show a moment in the process in which oxygen mask 12, 13 falls out of pouch 45, 47. It can be seen from the Figures that oxygen mask 12, 13 was lifted out of housing 3 during the opening movement of housing cover 5 and is now about to fall out of pouch 45, 47.

1. An apparatus for ejecting an oxygen mask, comprising:
a housing provided with a housing opening and having a housing cover which can be moved between a closed position in which the housing opening is covered at least in sections by the housing cover, and an open position,
an oxygen mask disposed inside the housing, in the closed position,
an ejector strap having one end which is connected to the housing cover,
characterized in that
the ejector strap co-operates in the closed position with a side of the oxygen mask which faces away from the housing cover, such that the oxygen mask is ejected from the housing by the housing cover moving into the open position.

2. The apparatus according to claim 1,
wherein the ejector strap engages at least partially behind a side of the oxygen mask facing away from the housing cover.

3. The apparatus according to claim 2,
wherein the ejector strap engages in the closed position at least partially behind a side of the oxygen mask facing away from the housing cover by means of a pouch in the ejector strap.

4. An apparatus according to claim 1,
wherein the housing cover is pivotable between the closed position and the open position.
